(19) United States
(12) Patent Application Publication
(10) Pub. No.: US 2002/0156674 A1
(43) Pub. Date: Oct. 24, 2002

(54) System and method for recruiting employees

(75) Inventors: Yoriko Okamoto, Yokohama (JP); Hiroyasu Takhashi, Yokohama (JP); Akiko Takahashi, Yokohama (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/020,305

(22) Filed: Dec. 14, 2001

(30) Foreign Application Priority Data
Dec. 27, 2000 (JP) 2000-397046

(51) Int. Cl. G06F 17/60

(52) U.S. Cl. 705/11; 705/8

(57) ABSTRACT

Efficient operation of an intermediate enterprise is achieved by disclosing, at all times, jobs for which employees are requested and the application status of applicants for those jobs. A network-connected server provides information in response to accesses by member clients via the network. The server includes: a job offer information database for storing job offer information that is managed for each job; an application acceptance unit for accepting applications from client terminals for jobs included in the job offer information; and a job offer information/application status generating unit for presenting to a new applicant not only the job offer information but also information concerning previous applicants who applied for each job included in the job offer information.

### FIELD OF THE INVENTION

The present invention relates to a recruiting system and method for providing job offer information via a server connected to a network, and for accepting applications from job hunters.

### BACKGROUND ART

An employment agent, an intermediary who provides a position placement service between applicants, including those who desire to be home workers or sub-contractors, and companies that have a need for sub-contractors or in-company workers, notifies registered job hunters of offered jobs when job offer information is received from companies. Several position placement transaction methods employed for this service are known, one of which is that job hunters are notified individually. Another is that all job hunters are notified of all available positions at one time and the agent waits for the submission of applications.

In the case that individual job hunters are notified of jobs offered, procedures are employed whereby a person is contacted by e-mail or by phone, for example, and confirmation is obtained as to whether or not a job is acceptable. Then, if the job offer is declined, the process is repeated with the next person in line.

In the case of one-time notification of all available jobs, procedures are employed whereby all registered job hunters are provided a job listing, via e-mail or paper media such as employment information magazines, accompanied by recruiting conditions, submission of applications, and distribution of final hiring or application rejection notifications. All of the conditions governing hiring are not normally revealed to applicants, and only upon their receipt of the final notifications do they know whether they have been hired for the jobs for which they applied.

Since computer networks, such as the Internet, have become so widely popular, these networks can be used instead of paper media, such as employment information magazines, for notifying registered members (job hunters) of the recruiting situation and for receiving applications from the members. If paper media are used, time is required for editing, printing and distribution, so that between the submission by a company of a hiring request and the acceptance of applications submitted by job hunters there is an extended time lag, which makes it difficult to allocate appropriate skill to meet sudden demands. Conversely, if computer networks are used, the time difference between the submission of a hiring request and the receipt of applications is reduced, and the ability to respond to sudden demands is enhanced.

However, using the above methods, the following problems have arisen when mediation is provided between job hunters and companies. When job hunters are notified individually that jobs are available, for each job an agent must contact one job hunter, and when a response is not immediately forthcoming from that person, the agent must wait a predetermined period of time before contacting another individual. Thus, in this case both time and labor are required for the distribution (notification) of position availability information.

When e-mail is used to collectively notify job hunters that jobs are available, although in this case the notification process is a one-time requirement, just as when individual notifications are used all applications must be processed and all persons who submitted them must be notified of the results by e-mail, so that the same labor effort is required.

Further, when collective notification is used for job availability, since application status is normally not revealed, in the time before applicants receive notices of the hiring results it is impossible for them to accurately evaluate their employment probabilities. Because, in many cases, applicants may have anticipated that they will secure the jobs for which they applied, when they receive rejection notices their morale may be adversely affected.

Furthermore, while taking into account the operating efficiency inherent in the collective notification of available jobs, the distribution of information concerning jobs for which employees are wanted is periodically performed at predetermined time intervals. In this case, if the information distribution interval were shortened the labor effort required for distribution would be increased. And if the distribution interval were extended, the time difference between the occurrence of an employment request and the acceptance of an application would be increased, and the ability to cope with sudden demands would be reduced.

It is, therefore, one object of the present invention is the efficient operation of an intermediate enterprise by disclosing, at all times, jobs for which employees are requested and their application status.

It is another object of the present invention to provide a high-quality intermediate business by determining the aptitude or suitability of applicants for jobs for which employees are wanted.

### SUMMARY OF THE INVENTION

To achieve the above objectives, according to the present invention, a network-connected server which provides information in response to accesses made by terminals via the network, comprises: a job offer information database for storing job offer information that is managed for each job; an information generating unit for providing the job offer information upon the receipt of requests from the terminals; a skill information database for storing skill information concerning skilled people requiring jobs; and an aptitude level determiner for determining an aptitude level for a skill required for each job. A job offer includes a demand for an employee as a sub-contractor or a dispatched employee, and similarly, a skill or skilled person includes an employee that contracts for work at home or by job units. An aptitude level is a score or a rank that represents how well the skill matches the recruiting conditions established by the job offer information (the aptitude to perform the work).

As a preferable method for determining an aptitude level, score data is provided for each recruiting condition set out in the job offer information, and the aptitude level for the skill can be calculated based on the recruiting condition and the skill information that is stored in the skill information database. Specifically, the scores set for the recruiting conditions that are satisfied by a skill are added together, and the obtained sum can be determined to be the aptitude level. The information generating unit can provide, for a terminal that accesses the server, the thus-obtained aptitude level together with the job offer information.

The server further includes: a performance record information database for storing performance information concerning the performance record of the skilled people who engaged in a predetermined job, wherein the aptitude level determiner obtains, from the performance record information database, the performance information, and determines the aptitude level by reflecting the performance information of the skilled people. The server further includes: an application acceptance unit, for accepting an application from the terminal for at least one of the jobs included in the job offer information, wherein the aptitude level determiner determines aptitude level for the job of an applicant whose application has been received by the application acceptance unit.

The server further includes: an employment/rejection determiner for employing information concerning the aptitude level that is obtained by the aptitude level determiner to determine whether to employ or to reject the applicant for each job included in the job offer information.

Further, according to the invention, a network-connected server which provides information in response to accesses by terminals via the network comprises: a job offer information database for storing job offer information that is managed for each job; an application acceptance unit for accepting an application, from the terminal, for at least one of the jobs included in the job offer information; and a job offer information generating unit, for presenting to a new applicant of the terminal, when accepting a new application, not only the job offer information but also information concerning previous applicants who applied for each job.

According to the present invention, a network-connected server which provides information in response to accesses made by terminals via the network comprises: job offer information generating means for preparing a screen, upon a request from the terminal, to present the job offer information, and for providing the job offer information to the terminal; and input means, for accepting an application that is issued for the job offer information by the terminal through the screen provided by the job offer information generating means, wherein the screen includes; a recruiting condition display area for displaying a recruiting condition for each of the jobs included in the job offer information, and a transmission object, for transmitting, to the input means, a notification of an application that designates a desired job. This screen can be prepared as a web page. In this case, the terminal user can obtain the job offer information from the server via a web-based network, such as the Internet, and issue an application for a desired job.

The screen further includes: an application status display area, for displaying application status for each of the jobs included in the job offer information. Since the application status are displayed, the terminal user can refer to the application status for a desired job, and can make an estimate relative to the probability of his or her employment. The screen further includes: an aptitude display area, for displaying, for each of the jobs in the job offer information, an aptitude level of an applicant in the job. Since the information concerning the aptitude of the applicant is disclosed, the terminal user can refer to the application status for a desired job, and can more precisely determine the probability of his or her employment.

According to the invention, an employee recruiting method, for providing job offer information via a server connected to a network, and for accepting an application for a job in a job offer, comprises the steps of: setting a score in accordance with a recruiting condition included in the job offer information; examining how many applicants for the job in the job offer satisfy the recruiting condition; generating information indicating aptitudes of the applicants in accordance with the scores that are set for the recruiting condition; and presenting, to a new applicant, the information indicating the aptitudes of the new applicant and the other applicants.

According to the invention, an employee recruiting method, for providing job offer information via a server connected to a network, and for accepting applications for jobs in a job offer, comprises the steps of: setting a score in accordance with a recruiting condition included in the job offer information; examining how many applicants for jobs in the job offer satisfy the recruiting conditions; determining the aptitudes of the applicants based on the score that is set for the recruiting conditions; and determining the employment of the applicants equivalent in number to the offered jobs in the job offer, in order of the highest aptitude level.

Further, according to the invention, a program can be prepared that permits a computer to execute the processes in the employee recruiting method, and a storage medium on which this program is stored can be provided.

### BRIEF DESCRIPTION OF THE DRAWINGS

FIG. 1 is a diagram for explaining the network configuration for an intermediate system according to one embodiment of the invention.

FIG. 2 is a diagram showing an example structure for a job offer information input web page according to the embodiment.

FIG. 3 is a diagram showing example settings for recruiting conditions according to the embodiment.

FIG. 4 is a diagram showing an example structure for a job offer information providing web page according to the embodiment.

FIG. 5 is a diagram showing an example structure for a price table according to the embodiment.

FIG. 6 is a diagram showing the processing for the intermediate service according to the embodiment.

### DESCRIPTION OF PREFERRED EMBODIMENT

The preferred embodiment of the present invention will now be described in detail while referring to the accompanying drawings.

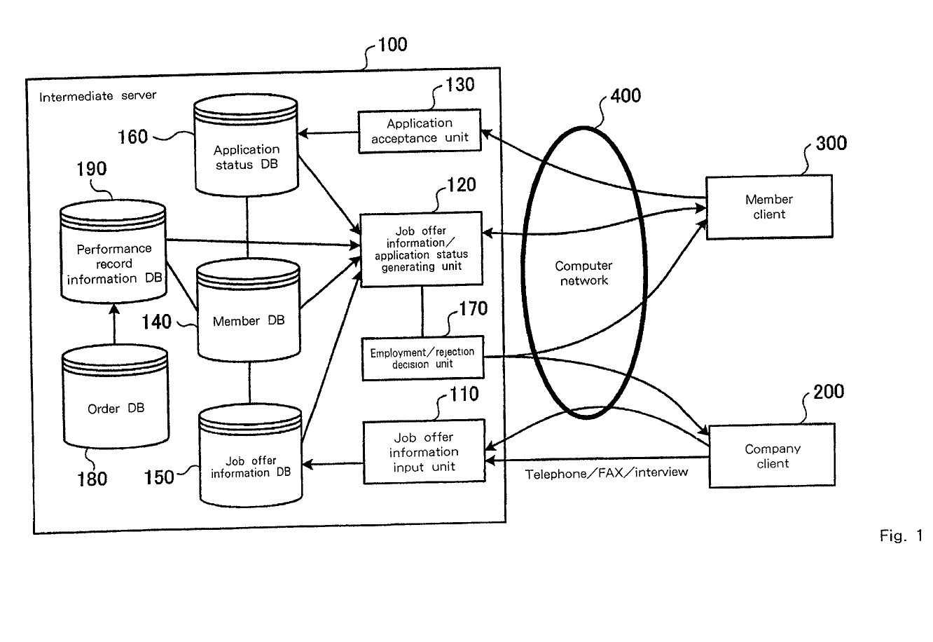

FIG. 1 is a diagram for explaining a network configuration that implements an intermediate system according to the embodiment. In FIG. 1, the intermediate system according to the embodiment comprises an intermediate server 100, a company client 200 and a member client 300, which are interconnected via a computer network 400, such as the Internet. In the explanation for this embodiment, an intermediate business is employed in a mode wherein job requests and job applications are repeated between a job provider that offers jobs and an applicant (or job hunter) who contracts for work. This mode is, for example, a case wherein orders are placed for each job, such as a home-based business or a contract business, or a case wherein a worker is hired for a comparatively short period of time or irregularly, such as a dispatched worker or a part-time worker hired for a year-end sale. It should be noted, however, that this embodiment can be applied for an ordinary job offer and for job hunting.

With the above configuration, the company client 200 is a terminal device (client machine) with which a job provider recruits employees via the server 100, and can be a computer, such as a personal computer or a workstation. When a web page is employed to exchange information with the server 100, as will be described later, the company client 200 includes a web browser. Actually, so long as the intermediate system of this embodiment is used to recruit employees, a job provider need not always be a company. However, to simplify the explanation given for this embodiment, a company is employed as a representative job provider, and a client machine used by this company is defined as the company client 200.

As another example, the job provider can include a server that corresponds to the intermediate server 100 for recruiting employees, and in this case, the company client 200 is not necessary. In this embodiment, however, for the sake of convenience, the intermediate server 100 and the company client 200 are separately provided, and the intermediate server 100 receives a request from the job provider and provides hiring mediation between the company and the applicant.

The member client 300 is a terminal device (client machine) with which a job hunter issues a job application to the company client 200 via the intermediate server 100, and can be a computer, for example, such as a personal computer, a workstation or a PDA (Personal Digital Assistant), a handy telephone, or a television set including a network function. When a web page is employed to exchange information with the server 100, as will be described later, the member client 300 includes a web browser.

As will be described later, in this embodiment, in order to provide efficient mediation, the aptitude or suitability of an applicant (hereinafter referred to as the aptitude level) is determined relative to a job that is to be provided by the company client 200. Thus, in principle, persons who are permitted to apply for the job via the intermediate server 100 are limited to members who are registered with the intermediate server 100. If the registration of a member can be performed after the member client 300 has accessed the intermediate server 100, an unspecified job hunter can also apply for a job after he or she has first accessed the intermediate server 100 and registered himself or herself as a member. Further, when the aptitude level of an applicant for a job is not important, an application issued by an unspecified job hunter can also be permitted.

The intermediate server 100 is a server machine that performs an intermediate business for notifying a job hunter of a job offered by a job provider, and can be, for example, a computer, such as a personal computer or a workstation. In this embodiment, the intermediate server 100 accepts, from the company client 200, a consignment for a job or for information concerning a job offer (hereinafter referred to simply as job offer information), and presents the job offer information as browsable content on the computer network 400, in order to acquire an application from the member client 300. Further, application status for each job for which an employee is to be recruited can also be presented. Specifically, a web page, for example, presenting the job offer information or the application status is prepared that a job hunter can browse via the Internet. In addition, a web page can be so prepared that it can accept an application from the member client 300.

Furthermore, the intermediate server 100 can also receive job offer information from the company client 200 via the Internet or another computer network 400. In this case, a web page, for example, having a predetermined input form for a job offer is also prepared, and when the company client 200 enters necessary data in the input form on the web page, the job offer information is accepted.

An explanation will now be given for the processing for employing the above web page to accept and distribute job offer information. An example structure for the web page will be described later. In FIG. 1, the intermediate server 100 comprises: a job offer information input unit 110, for accepting job offer information from the company client 200; a job offer information/application status generating unit 120, for preparing a web page carrying the job offer information and the application status; an application acceptance unit 130, for receiving an application from the member client 300; a member database (DB) 140, for storing member information; a job offer information database (DB) 150, for storing the job offer information; an application status database (DB) 160, for storing information about the application status for each job; an employment/rejection decision unit 170, for deciding the employment or rejection for an applicant; an order database (DB) 180, for storing information concerning the actual order submitted for a job by a business provider; and a performance record database (DB) 190, for storing the performance record of a member.

The job offer information input unit 110, which includes, for example, a CPU controlled by a program and an interface for the computer network 400, accepts the job offer information from the company client 200 and stores it in the job offer information database 150. The job offer information includes the content of a job and the numerical information for a recruiting condition. The job offer information can be received from the company client 200, via the computer network 400, by requesting the entry of the job type and the recruiting conditions on a web page used for a job offer information entry. Or, the job offer information can also be obtained by receiving necessary information using e-mail.

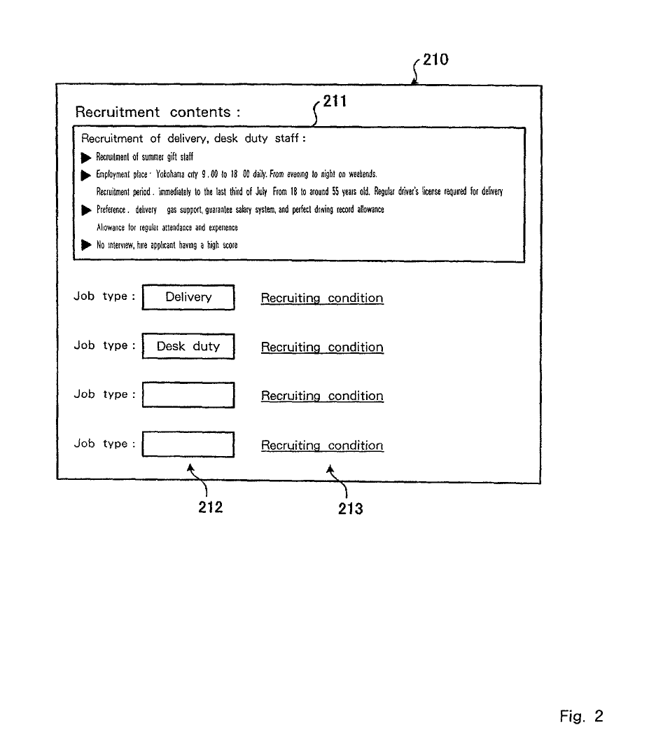

FIG. 2 is a diagram showing an example structure for a job offer information input web page. In FIG. 2, a web page 210 includes a column 211 for inputting the recruitment contents, which is an article to be published for the notification of applicants, and a column 212 for inputting a job type, and in addition, detailed recruiting conditions can be set for each job type. The recruiting conditions may be set, as is shown in FIG. 2, by forming a link 213 and shifting to a recruiting condition setting web page, or by preparing a recruiting condition setting form on the web page 210.

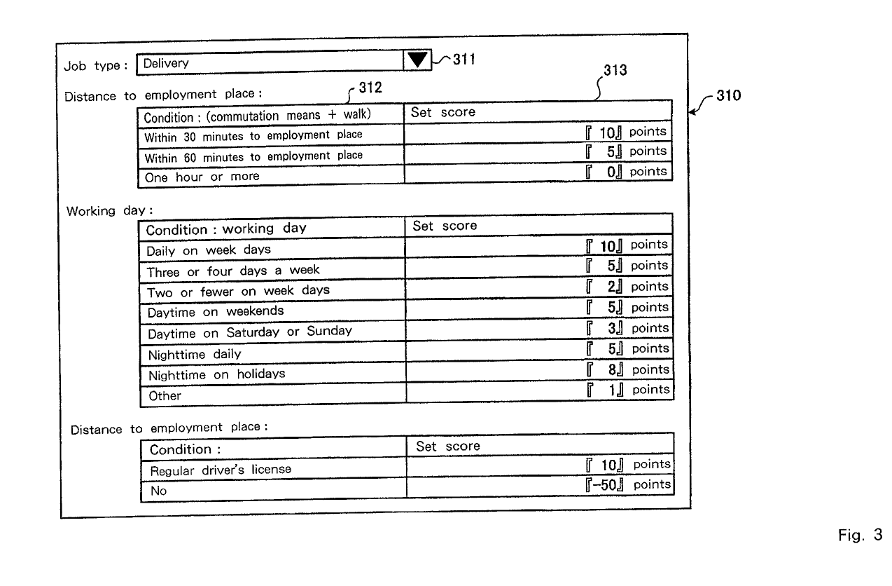

FIG. 3 is a diagram showing an example structure for a recruiting condition setting web page. In FIG. 3, a web page 310 includes a column 311 for setting a recruiting job type; a column 312 for displaying recruiting conditions; and a score input column 313 for establishing a score for each recruiting condition item (hereinafter referred to as a condition item). The column 311 for setting the recruited job type may be selected from job types, which are prepared in advance, on a pull-down menu, for example, or when the job type is set in the column 212, in FIG. 2, for inputting the recruiting job type, and the display is shifted to the web page 310 by a link corresponding to the input column 212, the job type set in the input column 212 may be set in the column 311 for setting the recruiting job type. When the job type is set in the column 311 for setting the recruiting job type, the recruiting conditions that are set in advance for the recruited job type are displayed in the column 312 for displaying the recruiting conditions.

In the example in FIG. 3, the recruiting conditions, such as the distance to the place of employment, the work date and the driver's license, are selected in accordance with the recruiting job type “delivery”, and the detailed condition items for the individual recruiting conditions are displayed. The scores that correspond to each condition item are set in the score input column 313. For example, the condition items, such as “within 30 minutes of the place of employment”, “within 60 minutes of the place of employment” and “equal to or longer than one hour”, are displayed for the distance to the employment place as recruiting conditions, and scores of 10, 5 and 0 are set in the score input column 313 that correspond to these condition items. A business provider can set an arbitrary score for each condition item for recruiting conditions, while taking the feature of the business into account. In the example in FIG. 3, the score is set for a pertinent condition item by entering a number in the appropriate space in the score input column 313.

On the web page 310 in FIG. 3, the recruiting conditions that are set in advance and the detailed condition items thereof are automatically displayed in accordance with the job type that is set in the column 311 for setting the recruiting job type. However, a business provider may select, from predetermined condition items, arbitrary condition item types for the recruiting conditions. The condition item types in the recruiting conditions are selected from predetermined condition items, because the condition items should be limited to constant contents, to a degree, so that the aptitude level can be calculated by comparing the score set for each condition item and the member information (which will be described in detail later). It should be noted, however, that updating, such as providing new recruiting conditions or a new condition item, or changing the recruiting conditions or the condition items, is permitted.

Further, although not shown, conditions, such as the number of employees to be recruited, the job level, the compensation, the term (the engagement period) and the application deadline, can be set in the job offer information. For the application deadline, not only the final date but also an intermediate date (an early application deadline) can be set. In this case, when the number of applications that are collected by the time the early application deadline is reached is equivalent to the number of employees requested, the acceptance of applications is closed. If at that time the number of applicants has not reached the requested number of employees, applications can be continuously accepted until the final deadline. Furthermore, when applications are accepted until the final deadline, preference can be given to members who submitted applications before the early deadline; for example, either they will be ensured of employment, or an additional score will be awarded them when the aptitude levels are calculated, which will be described later. In this manner, an element will be added for determining the employment or the rejection of an applicant in accordance with the order wherein applications were accepted. To use e-mail to receive the job offer information, the same information as above, i.e., the contents of the recruiting request, a job, the recruiting conditions for each operation and the score for each recruiting condition, is received by e-mail, and is registered in the job offer information database 150.

The job offer information can be accepted from the company client 200 via the computer network 400, as is described above, or it can be accepted by telephone, facsimile or an interview. In this case, the above described necessary information is presented, and to accept the job offer information, is registered in the job offer information database 150. When the job offer information is to be accepted by a method that does not use the computer network 400, the company client 200 is not a requisite for the business provider. However, in a case wherein the company client 200 is provided, a web page, which will be described later, where the job offer information and the application status are disclosed can be browsed so that the application status can be understood.

As is described above, since the business provider can set, in advance, the level of the skill for whoever contracts for work, and the level of a job (the quality of an expected product) as recruiting conditions, the level of an applicant can be adjusted and the risk that the job will not be filled can be reduced. Moreover, since the license of the applicant, the work history, the job reception record, past results, and various other conditions are objectively evaluated, the order for a job can be issued in accordance with these conditions, so that the types of jobs to be ordered to sub-contractors are increased, and operating costs can be reduced. In addition, when the aptitude level of the applicant is determined based on the recruiting conditions, the better or best skill can be obtained within the range of the compensation that is set in advance.

The job offer information/application status generating unit 120 employs the job offer information stored in the job offer information database 150 to prepare a web page carrying the job offer information and to provide it for browsing performed on the computer network 400. On the information providing web page, the application status and the aptitude level of a member are displayed for each job for which employees are being recruited. Since the job offer information is revealed to members on the web page, the time difference between the submission of a job offer and the acceptance of an application from a member can be reduced. Therefore, a sudden demand can be satisfactorily coped with.

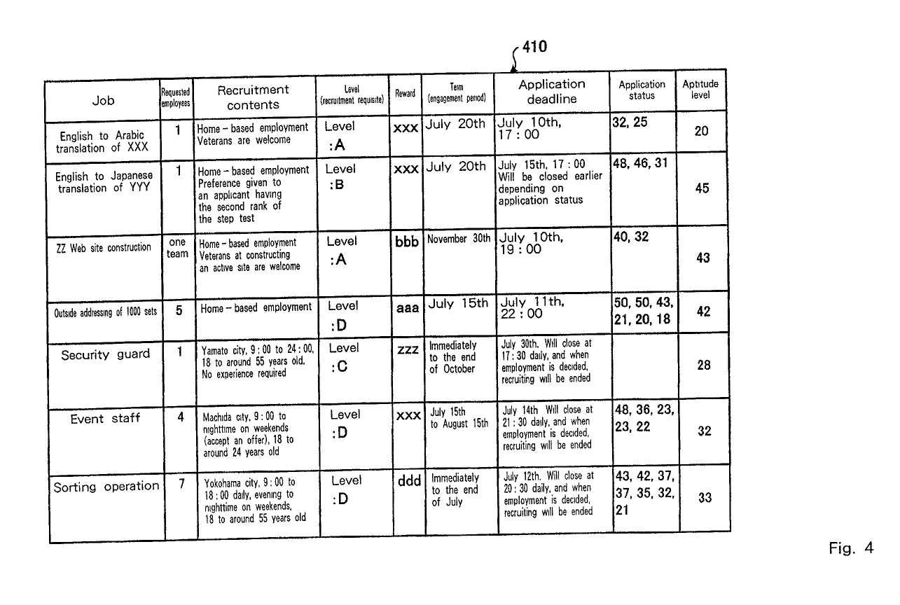

FIG. 4 is a diagram showing an example structure for a job offer information providing web page. In FIG. 4, on a web page 410, the recruiting conditions, i.e., the number of employees to be recruited, the job recruiting contents, the level (recruitment requisite), the compensation, the term (engagement period) and the application deadline, are displayed for seven jobs, i.e., translation from English to Arabic, translation from English to Japanese, the construction of a web site, outside addressing, a security guard, an event staff member, and a sorting operation. In addition, as current application status, the aptitude levels of the applicants (who have already submitted applications) are displayed for each job, as well as the aptitude level of the member who accesses the web page 410. Since the aptitude levels of the previous applicants are displayed, the number of persons who have already submitted applications for the job can also be obtained. For the compensation, while a single wage can be set for each job, in this example, a link is set to a wage table, so that, as will be described later, the wage can be set in detail, in accordance with the level of a job, by referring to the linked wage table.

The aptitude level will now be described. The aptitude level is a numerical value that represents the aptitude or suitability of a member for a job (a job for which employees are recruited based on the job offer information) that is carried on the web page 410. In order to receive the services offered by an intermediate according to this embodiment, an applicant must be a registered member, as is described above. For registration, information concerning age, address, the closest public transportation, a license, special skills and a desired job type is provided as part of the member information. This member information is subsequently stored in the member database 140. The types of information sought may vary depending on local laws or requirements. For example, some countries may have laws precluding gathering of age information as part of an employment process. In such countries, an applicant's age would not be sought. Similarly, if local public transportation is not readily available, the information sought may be whether the applicant can or cannot provide his or her own transportation to the job location.

The job offer information/application status generating unit 120 calculates the aptitude level of a predetermined member as follows, and displays the level on the web page 410. First, a target member is designated for calculation of the aptitude level, and his or her member information is obtained from the member database 140. Then, the items included in the member information are compared with those in the recruiting conditions for a job obtained from the job offer information database 150, and matched items are obtained. The scores provided for the individual recruiting conditions items are added together for the matched items, and the total value is determined to be the aptitude level of the target member for the pertinent job.

Assume that employees for deliveries and desk duty are recruited under the following recruiting conditions.

| | |
|---|---|
| Delivery job | |
| Commutation time: | within 30 minutes (ten points), |
| | within one hour (five points), |
| | one hour or more (0 points) |
| Working days: | daily (ten points), |
| | three days a week (five points), |
| | nighttime on weekends (eight points), |
| | others (three points) |
| Age: | 20 years or younger (ten points), |
| | in thirties (seven points), |
| | in forties (four points), |
| | in fifties (two points) |
| Driver's license: | yes (ten points), |
| | no (−50 points) |
| Working experiences: | yes rank A (ten points), |
| | yes rank B (seven points), |
| | yes rank C (five points) |
| | no (three points) |
| Desk duty | |
| Commutation time: | within 30 minutes (ten points), |
| | within one hour (five points), |
| | one hour or more (0 points) |
| Working days: | daily (ten points), |
| | three days a week (five points), |
| | nighttime or weekends (eight points), |
| | others (three points) |
| Age: | 20 years or younger (ten points), |
| | in thirties (seven points), |
| | in forties (four points), |
| | in fifties (two points) |
| Driver's license: | yes (ten points), |
| | no (ten points) |
| Working experiences: | yes rank A (ten points), |
| | yes rank B (seven points), |
| | yes rank C (five points) |
| | no (three points) |

Assume the aptitude level of the following member who issues an application for this recruitment: Resident in XX city (within one hour for commutation to the employment place), desires to work nights or weekends, 18 years old, no driver's license, has sorting operation work experience (rank A). When this member submits an application for the delivery job, his or her aptitude level is −17 points (=5+8+10+(−50)+10), while when he or she issues an application for the desk duty, the aptitude level is 43 points (=5+8+10+10+10).

Therefore, if this member applies for desk duty, he or she has a high probability of being hired due to the high aptitude level of 43 points (if it is determined that the applicant having the highest aptitude level is to be employed, that member will be employed if there no other applicant has an aptitude level that is equal to or higher than 43 points). When this member applies for the delivery job, the probability that he or she will not be employed is high, due to the low aptitude level of −17 points.

Since the aptitude level is the total value obtained for the scores provided for the recruiting condition items that match the member information items, a member who attains a high score based on capability conditions, such as the member's working record and the possession of a license is not distinguished from a member attaining a high score because of geographical location (commutation time) and a condition based on the number of working days. However, when an especially required recruiting condition is listed, a member who satisfies that condition can be selected by increasing the score awarded in that case. For example, according to the recruiting conditions in FIG. 3, the highest aptitude level is 50 points (this is obtained by adding the highest scores (ten points) for the five condition items), and −50 points is provided for the score when an applicant for the delivery job, for which driving is indispensable, has no driver's license. Thus, unless the applicant has a driver's license, his or her score is only −10 points, even though full scores are awarded for the other conditions, and essentially, has no possibility of being hired.

Arbitrary contents can be set for the member information items in accordance with the trend in which job offer information is submitted for jobs. A member presents the member information at the time of registration; however, information covering all the items need not always be presented. It should be noted, however, that the information that is not presented is not included when the score for the aptitude level is calculated. On the web page 410 in FIG. 4, only the aptitude level for the job that a member applied for is displayed in the application status column, and information for designating the member is not displayed. This is because, as will be described later, it is necessary for a specific member only to refer to the aptitude levels of applicants in order to determine whether to apply for a job.

Further, the aptitude level that is provided for a member who later refers to the web page 410 and applies for a job is also displayed in the aptitude level column. The member can be designated by the receipt of cookie information from the member client 300, or by including a setting for the ID information of a member in advance and by the ID information be entered when the member accesses the web page 410.

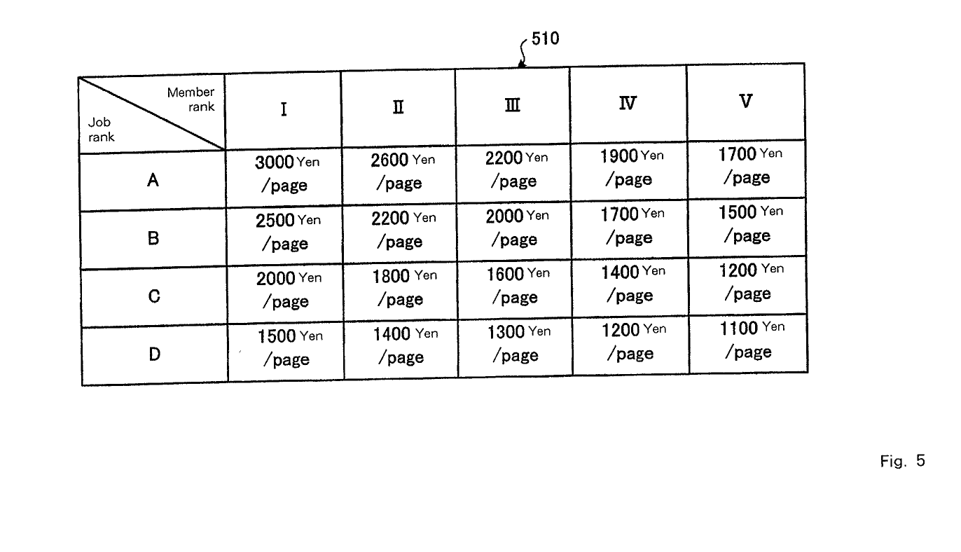

FIG. 5 is a diagram showing a wage table that is linked with the wage column on the web page 410 in FIG. 4. The wage table 510 in FIG. 5 is an example used for setting the compensation for a translation job. In the wage table 510 in FIG. 5, the compensation paid per page is set in accordance with the assigned job rank (A, B, C or D) and the rank of a member (I, II, III, IV or V). The job rank represents the level of importance of a job (corresponding to the “level (recruitment requisite)” on the web page 410 in FIG. 4), and the member rank represents the skill of a member. Therefore, at the same member rank, a higher compensation is allotted for a higher job rank, and at the same job rank, a higher compensation is allotted for a higher member rank. When the compensation is set in this manner in accordance with the member rank and the job rank, it can be assumed that the jobs are naturally sorted. That is, it is assumed that a member having a higher rank applies for a job having a higher rank in order to obtain a higher compensation, and that a member having a lower rank is employed for a job having one of the remaining ranks. The compensations shown in FIG. 5 are merely examples, and an appropriate compensation can be set in accordance with the contents of a job.

In order to apply for a desired job listed in the job offer information, the following method can be employed. First, the member client 300 accesses the intermediate server 100 to display the web page 410, selects a desired job, and clicks on a transmission object (button object, etc.) to transmit an application notification to the intermediate server 100 (a transmission object for transmission of an application notification is not shown in FIG. 4).

The application acceptance unit 130 accepts the application notification submitted by the member client 300 via the computer network 400, and stores the application notification in the application status database 160, correlating it with the information used to specify a target job, the information used to specify the member who applied for the job, and the aptitude level of the member for the job. In order for an application to be submitted by the member client 300, a button object for the transmission of the application notification is provided, for example, on the web page 410 in FIG. 4. In this case, to apply for a job listed on the web page 410 displayed on his or her machine, a predetermined member client 300 can designate a desired job by using a mouse to click on the relevant application notification button.

Thereafter, the information accumulated in the application status database 160 is used when the job offer information/application status generating unit 120 displays the application status column to prepare the job offer information providing web page 410 shown in FIG. 4. Specifically, to display the application status column for a predetermined job on the web page 410, first, the job offer information/application status generating unit 120 examines the application status database 160 to designate the member who applied for the job, and then obtains his or her aptitude level. Subsequently, the generating unit 120 displays the obtained aptitude level in the application status column on the web page 410.

Since by referring to the score, the member can objectively evaluate in advance how well his or her aptitude level matches the recruiting conditions, the member can seek employment in an occupation that is advantageous for himself or herself, can increase his or her capabilities and performance record, and can expect to receive an increased income. That is, when a license is obtained or the quality of the product produced during the performance of a contracted job is increased, this can constitute the basis for an increase in income. Further, since the job recruiting condition, the level of the job and the compensation are clearly displayed, the rate system can be understood exactly. Furthermore, since the application status for a job are revealed, the member can select an advantageous job that will afford him or her a higher income.

When the deadline is reached for each job for which employees are requested in the job offer information, the employment/rejection decision unit 170 decides on the employment or rejection of each applicant for a pertinent job. In this case, applicants equivalent in number to the employees to be recruited can be employed in order beginning with the applicant having the highest aptitude level. As is described above, since the aptitude level represents how well the member matches the recruiting conditions for a job, it is apparent that a member having a higher aptitude level is better suited aptitude for the pertinent job. Thus, the intermediate server 100 can mechanically decide whether to employ or reject an applicant based on the member's aptitude level. Thereafter, the employment/rejection decision unit 170 transmits a notification of the results to the applicants. Applicants may be individually notified of the results by e-mail, or a web page may be prepared for the employment/rejection notification for each job, so that the relevant applicants for the job can call up and read the page.

When an early deadline has been set for the submission of applications, the employment or rejection of applicants is decided (or the aptitude level of members whose applications have been received is increased) when the early deadline is reached. When the number of applicants who can be hired at that time does not correspond to the required number of employees, the final employment and rejection decision can be made when the final deadline is reached.

The order database 180 is used to store data concerning the employment/rejection of members who applied for jobs, and the results obtained in fulfilling the job order submitted by the business provider. The information concerning the employment/rejection decisions and the results provided for the hire order is used to manage the members who are engaged, and is also referred to when performance record information is obtained, which will be described later.

The performance record database 190 is used to store for each member the performance record information that represents job achievement results. This performance record information is obtained by correlating the results achieved for a predetermined job with a member who was engaged in performing the job. The obtained performance record information can be thereafter be used for preparing an evaluation of the member. Specifically, the performance record information is recalculated obtain a score based on an appropriate rule, and the obtained score is added, as needed, to the aptitude level of the member. For example, assume that a specific member is experienced in the performance of a specific job because of repetitively performance of the job and thereby is awarded a higher evaluation. When this member again applies for the same type of job, the score based on this performance record information is added to the aptitude level, and the newly obtained aptitude level is employed. The score obtained by recalculating the performance record information may be stored in advance in the performance record database 190, and the score may be read therefrom when the aptitude level of the specific member is being calculated. When the performance record of a member obtained by performing a job is reflected in the aptitude level, a detailed decision is available for determining the aptitude of the member for the performance of a job (to calculate the aptitude level). The rank of the member (a translator) for the translation job is merely an example used describe how a member is evaluated based on the performance record information.

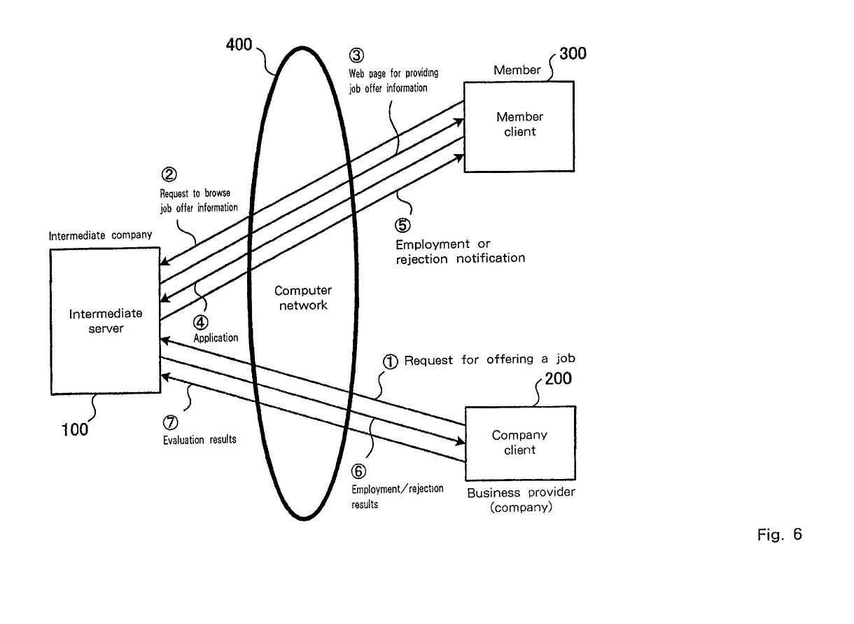

FIG. 6 is a diagram showing example processing performed by the intermediate server according to the embodiment. In FIG. 6, an intermediate company manages the intermediate server 100, and acts as an intermediate on the computer network 400. First, a company, which is a business provider, requests that the intermediate company introduce a sub-contractor or an employee for a designated job. With this request, the company transmits, to the intermediate company, job offer information including the above described recruiting condition, and the information is stored in the job offer information database 150 of the intermediate server 100.

Next, a member who is a job hunter employs the web browser of the member client 300 to forward a request to the intermediate server 100 to be permitted to browse the job offer information providing web page 410, and then, the job offer information/application status generating unit 120 of the intermediate server 100 prepares the job offer information providing web page 410 for the member. Specifically, the job offer information/application status generating unit 120 obtains the job offer information from the job offer information database 150; obtains the application status from the application status database 160 for each job in the job offer information and displays the application status on the web page 410; obtains the member information of the member from the member database 140 and compares the member information with the job offer information obtained from the job offer information database 150; and calculates the aptitude level of the member for each job and displays it on the web page 410. The web page 410 is then transmitted to the member client 300. Thus, the member can obtain his or her aptitude level for each job, and the current number of applicants for each job and their aptitude levels.

On the web page 410 in FIG. 4, it is understood that since the aptitude level of the member is 43 points in web site construction and is higher than that of another applicant, this member can be employed unless an applicant having a higher aptitude level appears (since a team of persons is requested for this job, the member having the lower aptitude level could also be employed; however, so long as an applicant's aptitude level is the highest, that applicant is certain to be employed). Further, as for the event staff member, the sorting operation or the envelope addressing job, compared with the aptitude levels of other applicants, the aptitude level of that member ranks the applicant within the requested number of employees, so that apparently, this member can be employed for these jobs. Further, while for the security guard, the aptitude level of the member is 28 points which is not so high, currently there are no other applicants, and the member could be employed. For the translation of English to Japanese, although the aptitude level of the member is 45 points which is comparatively high, the aptitude levels of the other applicants are higher, and only one employee is required. Thus, it is apparent that this member can not be employed unless the other applicants cancel their applications.

For each recruited job, a member can compare his or her aptitude level with the aptitude levels of the other applicants, determine which job is best while taking the recruiting conditions into account, and can apply for the job. Therefore, a member can efficiently search for and apply for a job for which he or she will probably be hired, and the business provider can obtain a superior employee whose skills match the recruiting conditions well. Further, since it is expected that members who would probably not be hired would avoid submitting applications, the business provider can reduce the labor effort required for the transmission of employment or rejection notifications, so that an efficient recruitment process can be performed.

Further, when an early application deadline is set, members are requested to submit applications as early as possible. For example, when the early deadline is set, such as “English to Japanese translation of YYY”, but no actual due date is specified, members must apply for that job as soon as possible. Further, for the jobs, such as “security guard”, “event staff member” and “sorting operation”, for which the acceptance of applications is temporarily closed, members must apply for a job before the number of persons hired reaches the requested number of employees. The date for the early deadline is not specified, as in “English to Japanese translation of YYY”, because members are requested to apply for this job as soon as possible. That is, if the date for the early deadline is unknown, the members do not know when the application period expires, and can not wait until the final date for the deadline to apply for the job. As a result, as the employment reference, the members are notified that applicants will be hired in the order of receipt of applications.

When the application deadline under the recruiting conditions has been reached, the employment/rejection decision unit 170 of the intermediate server 100 determines whether applicants are to be employed or rejected, and transmits the results of the employment or the rejection decision to the company client 200 and the member client 300.

Based on the decision made by the employment/rejection decision unit 170, the business provider may simply employ the applicants in the order beginning with the member having the highest aptitude level, or may determine which applicants to hire in accordance with their aptitude levels and by using another selection method, such as an interview. As is described above, the aptitude levels indicate which members abilities match the recruiting conditions for jobs. Therefore, for a job, such as translating, envelope addressing or cleaning, that requires a special capability or experience, or for a home-based job, an employee whose ability matches job requirements can probably be obtained simply by selecting the applicant having the highest aptitude level.

For a customer service job, such as an event staff member or a telephone operator, an element that can not be represented numerically because of a recruiting condition, such as personality and compatibility with other staff members, is important, and the employment or rejection of an applicant can not be determined based merely on an aptitude level score. Thus, in this case, selection by interview is employed in addition to using an aptitude level. When the interview is started beginning with the member having the highest aptitude level, the selection of applicants can be performed efficiently because an applicant who is interviewed earlier may satisfy the recruiting condition better. When another selection method is to be used while the aptitude level is also taken into account, the employment/rejection decision unit 170 does not transmit an employment/rejection notification to the member, but instead the business provider transmits a notification directly to a member.

When the employment/rejection decision unit 170 has determined whether an applicant is to be employed or rejected, based on this result, information concerning the member who is hired and the job (hereinafter referred to as the employment information) is stored in the order database 180. When a business provider determines whether an applicant is to be employed or rejected, without relying on the employment/rejection decision unit 170, the business provider transmits the employment information to the intermediate server 100, and the information is stored in the order database 180. Also, in this case, since it is apparent that the employment/rejection decision unit 170 performs the selection of a predetermined applicant as a target for an interview, a notification of that effect can be transmitted to the applicant, instead of an employment/rejection notification.

Further, the business provider evaluates the job achievements of the member who is hired and his or her performance record, and transmits the evaluation results to the intermediate server 100. The intermediate server 100 designates a member by comparing the received performance record information with the employment information, and stores the performance record information for the member in the performance record database 190. As is described above, before or after a member applies for a job, the performance record information can be used as needed to calculate the aptitude level of the member.

For the provision of a service in the above described embodiment, the business provider pays a wage to the member, and pays an intermediate commission fee to the intermediate company. For this payment, the business provider may pay the member and the intermediate company independently, or may pay the intermediate company all the money by adding together the wage for the member and the commission fee for the intermediate company. Thereafter the intermediate company pays the member the wage earned by subtracting the commission fee from the total amount paid. Further, as an operating expense for the intermediate company, in addition to the commission fee paid by the business provider, a membership fee can be collected from the member.

In the above embodiment, the intermediate company is present in addition to the business provider and the member, and the intermediate server 100 is provided by the intermediate company. However, the business provider may include a server that functions the same as the intermediate server 100, and may handle the recruiting of employees. In his case, the server may have an additional function consisting of the automatic issue of a job notification to a member who the employment/rejection decision unit 170 has determined is to be hired.

In addition, in this embodiment, the scores set for the recruiting conditions for the job offer information are compared with the member information for a member who is an applicant, and the aptitude level of the member is calculated by adding together the scores for the recruiting conditions that the member's capabilities satisfy. However, since the aptitude level represents the aptitude of a member for a specific job, instead of using the scores, as is described in FIG. 5 for the setting the compensation for translation, the members and jobs can be ranked using an appropriate reference, and the aptitude level can be set based on these ranks.

What is claimed is:

1. A server, which is connected to a network and provides information in response to accesses made by terminals via said network, comprising:
a job offer information database, for storing job offer information that is managed for each job;
an information generating unit, for providing said job offer information upon the receipt of requests from said terminals;
a skill information database, for storing skill information concerning skilled people requiring jobs; and
an aptitude level determiner, for determining an aptitude level for a skill required for each job based on the job offer information and the skill information.

2. A server according to claim 1, wherein said job offer information to be stored in said job offer information database includes score data that was set in accordance with a recruiting condition; and wherein said aptitude level for said skill is calculated based on said recruiting condition and the skill information that is stored in said skill information database.

3. A server according to claim 1, further comprising a performance record information database, for storing performance information concerning the performance record of said skilled people who engage in a predetermined job, wherein said aptitude level determiner obtains said performance information, and determines the aptitude level based on the performance information of the skilled people.

4. A server according to claim 1, wherein said information generating unit provides, for said terminals, not only said job offer information but also information about aptitude level determined by said aptitude level determiner.

5. A server according to claim 1, further comprising an application acceptance unit, for accepting an application from one of said terminals for at least one of said jobs included in said job offer information, wherein said aptitude level determiner determines aptitude level in said job of applicant whose application has been received by said application acceptance unit.

6. A server according to claim 5, further comprising an employment/rejection determiner, for employing information concerning said aptitude level that is obtained by said aptitude level determiner to determine whether to employ or to reject the applicant for each job included in said job offer information.

7. A server, which is connected to a network and provides information in response to accesses by terminals via said network, comprising:
a job offer information database, for storing job offer information that is managed for each job;
an application acceptance unit, for accepting an application from one of said terminals, for at least one of said jobs included in said job offer information; and
a job offer information generating unit, for presenting to a new applicant of said terminal, when accepting a new application, not only said job offer information but also information concerning previous applicants who applied for each job.

8. A server according to claim 7, wherein said job offer information generating unit presents, to said new applicant, the aptitude level of the previous applicants for each job in said job offer information, as well as the aptitude level of said new applicant for the job.

9. A server according to claim 8, wherein said job offer information to be stored in said job offer information database includes a score data that was set in accordance with a recruiting condition, and wherein said job offer information generating unit presents, as said aptitude level of said previous applicants and said new applicant, scores that are calculated based on how well said previous applicants and said new applicant match said recruiting condition.

10. A server, which is connected to a network and provides information in response to accesses made by terminals via said network, comprising:
job offer information generating means, for preparing a screen, upon a request from said terminal, to present said job offer information, and for providing said job offer information to said terminal; and
input means, for accepting an application that is issued for said job offer information by said terminal through said screen provided by said job offer information generating means, wherein said screen includes
a recruiting condition display area, for displaying a recruiting condition for each of said jobs included in the job offer information, and
a transmission object, for transmitting, to the input means, a notification of an application that designates a desired job.

11. The server according to claim 10, wherein said screen provided by said job offer information generating means further includes an application status display area, for displaying application status for each of said jobs included in said job offer information.

12. A server according to claim 10, wherein said screen further includes an aptitude display area, for displaying, for each of said jobs in said presented job offer information, an aptitude level of an applicant in said job.

13. An employee recruiting method, for providing job offer information via a server connected to a network, and for accepting an application for a job in a job offer, comprising the steps of:
setting a score in accordance with a recruiting condition included in said job offer information;
examining how many applicants for said job in said job offer satisfy said recruiting condition;
generating information indicating aptitudes of said applicants in accordance with said scores that are set for said recruiting condition; and
presenting, to a new applicant, said information indicating the aptitudes of said new applicant and the other applicants.

14. An employee recruiting method, for providing job offer information via a server connected to a network, and for accepting applications for jobs in a job offer, comprising the steps of:
setting a score in accordance with a recruiting condition included in said job offer information;
examining how many applicants for jobs in said job offer satisfy said recruiting conditions;
determining the aptitudes of said applicants based on said score that is set for said recruiting conditions; and
determining the employment of the applicants equivalent in number to the offered jobs in said job offer, in order of the highest aptitude level.

15. A storage medium having a computer readable program, which permits a computer to perform:
a process for holding job offer information in which a score is set in accordance with a recruiting condition;
a process for examining how many applicants for said job in said job offer satisfy said recruiting condition, and for generating information indicating aptitudes of said applicants in accordance with said scores that are set for said recruiting condition; and
a process for presenting, to a new applicant, said information indicating the aptitudes of said new applicant and the other applicants.

16. A storage medium having a computer-readable program, which permits a computer to perform:
a process for holding job offer information in which a score is set in accordance with a recruiting condition;
a process for examining how many applicants for jobs in said job offer satisfy said recruiting conditions, and for determining the aptitudes of said applicants based on said score that is set for said recruiting conditions; and
a process for determining the employment of the applicants equivalent in number to the offered jobs in said job offer, in order of the highest aptitude level.
